(19) United States
(12) Patent Application Publication
(10) Pub. No.: US 2005/0088449 A1
(43) Pub. Date: Apr. 28, 2005

(54) Child window redirection

(76) Inventors: Leonardo E. Blanco, Redmond, WA (US); Andrei Baioura, Bellevue, WA (US); Mohamed A.M. Sadek, Kirkland, WA (US); Gregory D. Swedberg, Bellevue, WA (US); Pravin K. Santiago, Bellevue, WA (US)

Correspondence Address: LEE & HAYES PLLC, 421 W RIVERSIDE AVENUE SUITE 500, SPOKANE, WA, 99201, US

(21) Appl. No.: 10/692,322

(22) Filed: Oct. 23, 2003

(51) Int. Cl. G09G 5/36

(52) U.S. Cl. 345/547; 345/545

(57) ABSTRACT

The visual output of legacy child windows intended for display on a non-legacy parent are redirected to an off-screen bitmap buffer. A display component having enhanced visual functionality processes the output of the legacy child window with any of a number of visual effects. The display component composes the parent window by combining the non-legacy visual output with the processed output of the legacy child window. In this way, visual enhancements that have been technologically unavailable to the legacy child windows may be applied to the legacy child windows when used in combination with a new-technology parent window.

### TECHNICAL FIELD

This application relates generally to the display of information in a computing system, and more specifically to making enhanced functionality available to legacy display components.

### BACKGROUND OF THE INVENTION

Software programs today typically include many visual representations of data. In most cases, these visual representations are rendered in what are commonly referred to as “windows.” A program executing on a computer may use very many windows in the performance of its duties. In addition, what the layperson thinks of as a single window may in fact be several windows from the perspective of the host computing system. For example, a main window displayed on screen may include an image, a group of options, and some buttons. From the perspective of the computing system, each of those components may itself be a window. In this example, the main window would be termed the “parent window” and each sub-window would be termed a “child window.”

Most often, software programs are constructed by defining the layout of one or more parent windows and including child windows as the functionality of the program or desires of the developer warrant. In one simple example, a developer may create a main window for a program and include on that window a pair of buttons. Each of those buttons are a child window of the main window. The developer may also include a container window that has a set of mutually-exclusive options (e.g., radio buttons). In that case, the container window is a child of the main window, and the options are children of the container.

It will be appreciated that developers commonly reuse code when creating new software programs. Developers commonly reuse window components such as buttons, list boxes, image boxes, and the like. This makes developing new software programs much more efficient. But at the same time, until new window components are created, any new functionality made available by the technological advancement of computing systems is not available. For various reasons, if new functionality is developed for window components, new programs created with pre-existing incarnations of those components may not be able to take advantage of the new functionality. Until now, a solution to that problem has eluded software developers.

### SUMMARY OF THE INVENTION

Briefly stated, the visual output of legacy child windows intended for display on a non-legacy parent are redirected to an off-screen bitmap buffer. A display component having enhanced visual functionality processes the output of the legacy child window with any of a number of visual effects. The display component composes the parent window by combining the non-legacy visual output with the processed output of the legacy child window. In this way, visual enhancements that have been technologically unavailable to the legacy child windows may be applied to the legacy child windows when used in combination with a new-technology parent window.

### BRIEF DESCRIPTION OF THE DRAWINGS

FIG. 1 is a functional block diagram of an exemplary computer suitable as an environment for practicing various aspects of subject matter disclosed herein.

FIG. 2 is a functional block diagram of a computing environment that includes components to make enhanced available to legacy window components used in software programs.

FIG. 3 is an illustrative screen display of a possible arrangement of window components for the visual output of the application of FIG. 2.

FIG. 4 is a functional block diagram generally illustrating an off-screen buffer for containing redirected legacy child window output.

FIG. 5 is a logical flow diagram generally illustrating operations that may be performed by a process implementing a technique for making available visual enhancements to a legacy window system.

FIG. 6 is a logical flow diagram generally illustrating steps that may be performed in a process for drawing or redrawing windows in a program that includes both legacy windows and new windows.

FIG. 7 is a logical flow diagram generally illustrating a process for handling input to a window having both legacy and non-legacy content.

### DETAILED DESCRIPTION

The following description sets forth a specific embodiment of a system for redirecting child windows of an application to enable enhanced window component functionality. This specific embodiment incorporates elements recited in the appended claims. The embodiment is described with specificity in order to meet statutory requirements. However, the description itself is not intended to limit the scope of this patent. Rather, the inventors have contemplated that the claimed invention might also be embodied in other ways, to include different elements or combinations of elements similar to the ones described in this document, in conjunction with other present or future technologies.

Exemplary Computing Environment

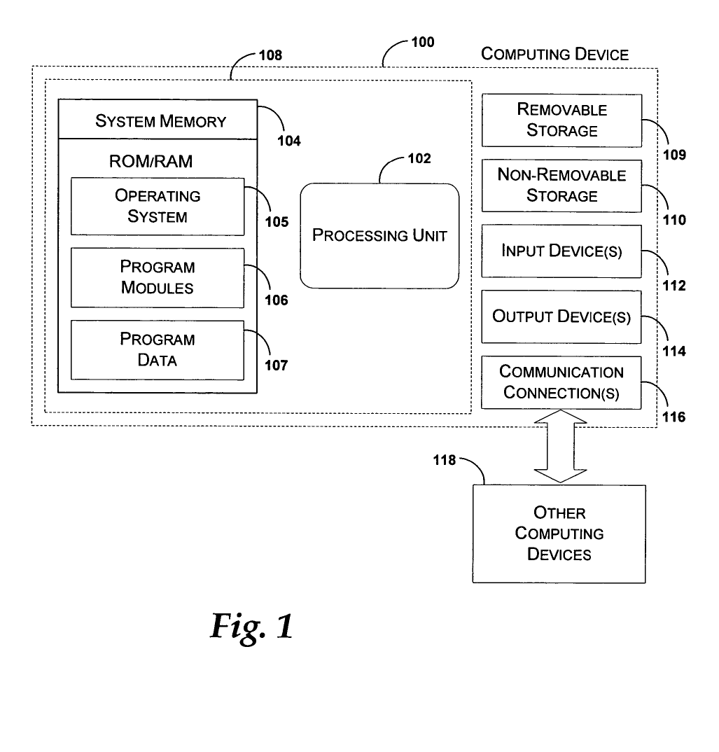

FIG. 1 is a functional block diagram illustrating an exemplary computing device that may be used in embodiments of the methods and mechanisms described in this document. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more program modules 106, and may include program data 107. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well know in the art and need not be discussed at length here.

Computing device 100 may also contain communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

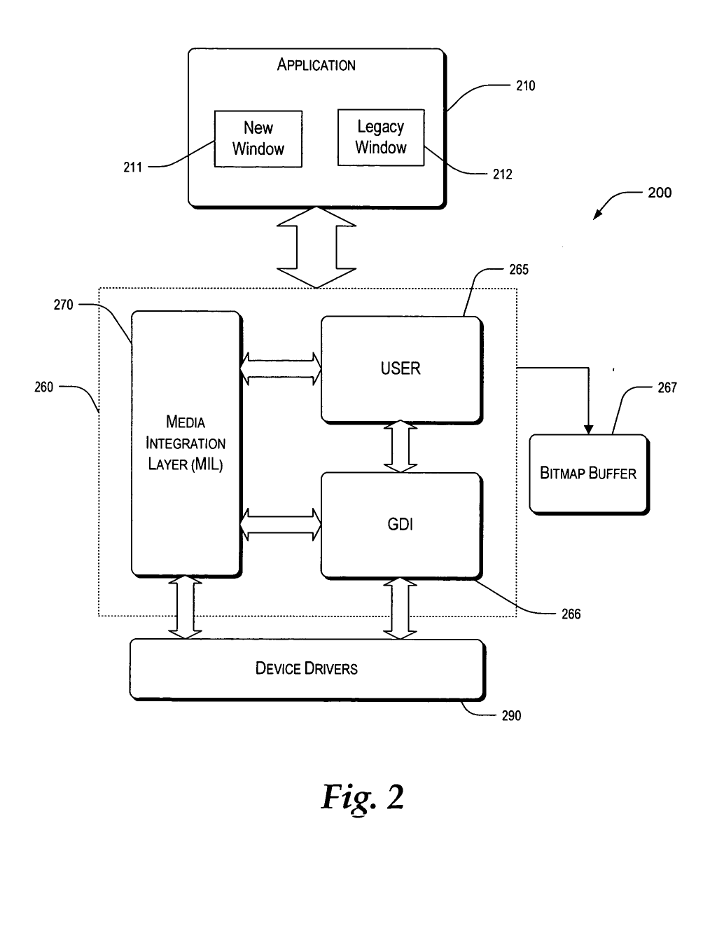

FIG. 2 is a functional block diagram of a computing environment 200 that includes components to make enhanced available to legacy window components used in software programs. Illustrated in FIG. 2 are an application 210, a window management and display subsystem 260, and device drivers 290. The window management and display subsystem 260 contains components that are configured to support the management and display of windows and other visual components on behalf of executing programs or other processes. A window manager component 265 (commonly referred to as a “user” component) and a Graphics Device Interface (GDI) component 266 together provide basic window management and display functionality to very many traditional applications.

Generally stated, the user component 265 manages the structure and layout of any legacy windows used by executing applications or other programs, including operating system processes. The user component 265 maintains its own internal structures and the like that represent the locations and relative positions of each window being displayed on screen. The user component 265 has been configured with the ability to create a bitmap buffer 267 as needed. The bitmap buffer 267 is an off-screen memory location in which may be stored a visual representation of window content (e.g., a bitmap of the window).

The GDI component 266 performs operations, including clipping and compositing, necessary to render the display of legacy windows upon instruction by the user component 265. Essentially, the GDI component 266 provides a device-independent platform for programs to supply their visual output. The GDI component 266 interacts with several device drivers 290 and the like to make actual visual output appear on a piece of display hardware. The GDI component 266 also has an ability, that can be publicly activated through interfaces, to redirect the output of window content intended for the screen (e.g., from a screen buffer) to the bitmap buffer 267.

The user component 265 and the GDI component 266 work closely together to ensure that windows are properly clipped and composed on screen based on which portion of which windows are supposed to be visible. In addition, the user component 265 and the GDI component 266 cooperate closely to handle certain types of input, such as identifying the relevance to a program of a mouse click. Unfortunately, however, the relatively-limited visual functionality made available to window components by the user/GDI combination has over time left many developers wanting more. As used in this document, the term “legacy windows” means window components that are designed for use specifically with the user/GDI combination of window management components. Stated another way, “legacy windows” are windows that are not constructed to take advantage of the enhanced functionality made available through the Media Integration Layer (MIL) component 270.

The MIL component 270 is a display subsystem that provides applications with enhanced window display functionality over that made available by the user/GDI combination. For instance, the MIL component 270 is configured to allow programs to use arbitrarily sized, shaped, and located window components, whereas the user/GDI combination typically recognizes only static, rectangular windows. Examples of the functionality made available by the MIL component 270 include support for arbitrarily sized, shaped, and located window components, transparency for window components, the ability to add special effects to the window components like rotation and translation, and generally enhanced visual effects for each window component. Until now, most of this enhanced functionality has been unavailable to programs for any legacy windows used by those programs. The enhanced functionality has been available only to “new windows,” meaning window components that have been specifically constructed or modified to interact with the MIL component 270.

The MIL component 211 includes sufficient capability to provide window management and rendering without resort to either the user component 265 or the GDI component 266. However, it is envisioned that the MIL component 211 will interact with the user/GDI combination in cases where a client program uses legacy window components. The MIL component 211 has been constructed to interact with the user component 265 and the GDI component 266 to support legacy window components while reducing the number of modifications to either the user component 265 or the GDI component 266, thereby minimizing the potential impact on legacy applications that do not take advantage of the MIL component 211.

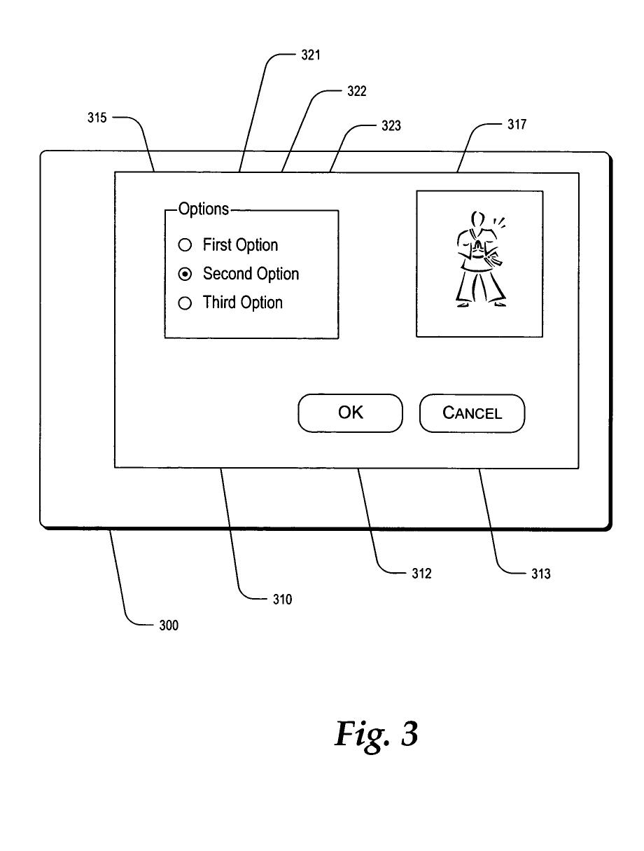

The application 210 may be any software program, but in this particular embodiment is a software program constructed to make use of windows for the display of data. In particular, the application 210 includes code that invokes at least two different types of windows: a new window 211 and a legacy window 212 that is a child of the new window 211. The new window 211 may be any window of the application 210 and with which a user may interact with the application 210. The legacy window 212, in this example, is a window component of the new window 211. As mentioned above, the new window 211 is created to take advantage of the enhanced functionality made available by the MIL component 211 and to interact with the MIL component 211 for its administration and management. In contrast, the legacy window 212 has been constructed to interact with the user component 265 and the GDI component 266 for its administration and management. Although only one new window 211 and one legacy window 212 are shown, it will be appreciated that many such windows, in arbitrary combinations, may be included in the typical software program. One example of a possible arrangement is illustrated in FIG. 3.

FIG. 3 is an illustrative screen display 300 of a possible arrangement of window components for the visual output of the application 210. In this example, a main window 310 corresponds to the new window 211 in that the main window 310 is constructed to interact with the MIL component 270 directly. Accordingly, the MIL component 270 is also responsible for at least part of the administration and management of the several child window components on the main window 310. Those child window components include a pair of buttons (i.e., button A 312 and button B 313), a frame 315, and an image 317. The frame 315 encloses three selectable option buttons: first option 321, second option 322, and third option 323.

Each of the window components is a child of the main window 310 and may be either a legacy window or a new window. For example, the image 317 may be a legacy window, and as such, may exhibit limited functionality. In short, the image 317 may include no native capability for anything except displaying itself at a particular Cartesian coordinate on its parent window. However, when used in connection with the MIL-aware main window 310, the enhanced functionality is made available to it through the use of the techniques and mechanisms described in this document. For example, the MIL component 270 may provide the ability to rotate the image 317 or translate it across the main window 310 while applying transparency.

Under ordinary circumstances, any legacy child windows on the main window 310 would locate themselves on the main window 310 and cause themselves to be painted to the screen. This would be accomplished by the parent window instructing its children to makes themselves visible. In response, the child windows (such as the image 317) would issue instructions to the GDI component 266 to paint themselves, and the GDI component 266 would render the child windows in a screen buffer for display on screen. However, in accordance with this system, the main window 310 is MIL-aware, and as such, the MIL component 270 has an opportunity to intercede. Accordingly, the main window 310 instructs the user component 265 and the GDI component 266 to redirect the display of each legacy window to the off screen bitmap buffer 267. By outputting the windows to the bitmap buffer 267, the MIL component 270 may perform pre-processing activities on the window content before rendering it to the display (screen buffer). Any one or more of the child windows may be redirected in this manner and thus benefit from the enhancements made available by the MIL component 270.

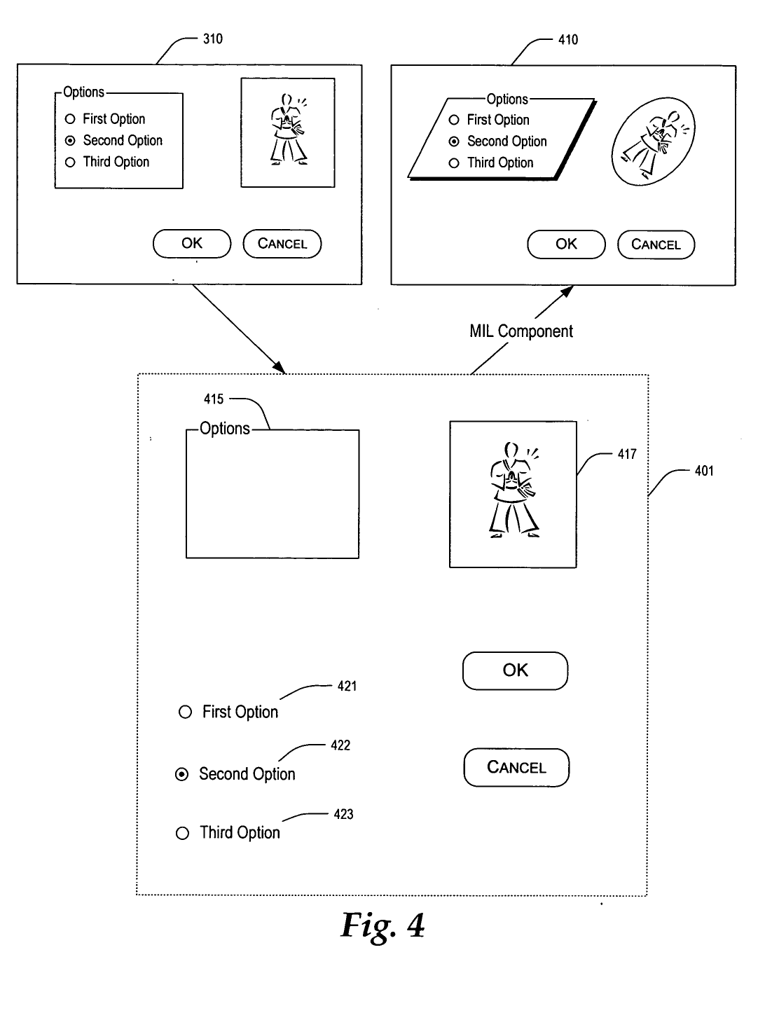

Referring briefly to FIG. 4, off screen memory 401 includes at least one, but likely multiple memory locations in which to store the visual output of each redirected child window. Although illustrated as one contiguous buffer, it is envisioned that each child window may be rendered to its own individual buffer. It will be appreciated that the visual content of each window is rendered off screen separate from the content of other windows. For example, the frame 415 is rendered as a window that does not overlap with any other windows and is not occluded by any other window content, namely the three option buttons (first option 421, second option 422, and third option 423), which are also rendered separate from the other child windows.

In the off screen memory 401, the MIL component 270 has access to each child window and may apply any enhancement or visual effect to the child windows before rendering them to the main window 310. In one example, the MIL component 270 may rotate, skew, or otherwise alter each of the child windows before rendering them to the display, possibly resulting in the enhanced main window 410 as shown. Of course, many possibilities exist for transforming the child windows.

Thus, although the legacy child windows do not natively support the features available through the MIL component 270, through this redirection technique, the MIL component 270 can capture the window component output and apply those features. It should also be noted that any child windows that are not legacy windows need not be rendered off screen, but rather may be managed by the MIL component 270 in the ordinary manner. Accordingly, FIG. 4 shows all the child window components of the main window 310 rendered off-screen only to illustrate the possibility that all the child windows may be legacy windows. However, if any child windows are not legacy windows, they would not be rendered to the off screen bitmap buffer 267.

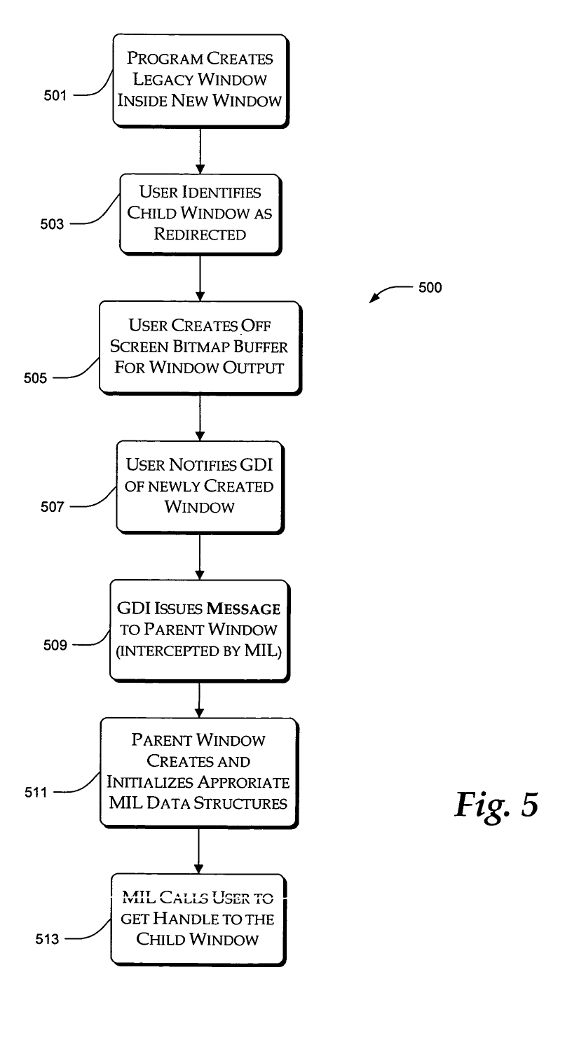

FIG. 5 is a logical flow diagram generally illustrating operations that may be performed by a process 500 implementing a technique for making available visual enhancements to a legacy window system, such as has been described above. The process 500 begins at step 501, where a program begins to create a legacy window within a new window, as those terms were defined above. The creation of legacy windows involves the use of the user component 265, so that component gets notice of the creation of the legacy window. However, because the parent window is a new window, the user component 265 identifies the child window as a redirected window at step 503. Identifying the child window may be by express notification given by the parent window, or alternatively it may be an implied notification, such as by information associated with a class identifier for the child window or perhaps by a flag set in a data structure associated with the child window.

At step 505, the user component 265 creates the off-screen bitmap buffer 267 to receive the output of the child window rendering process. At step 507, the user component 265 notifies the GDI component 266 that the new child window has been created and to redirect the window output of the child window to the bitmap buffer 267.

At step 509, the GDI component 266 issues a notification to the parent window that the child window is now ready to be redirected off screen. In this embodiment, the MIL component 270 intercepts the notification through a mechanism called “window hooking.” The GDI component 266 may be modified to issue new window messages to notify the parent window/MIL component that a redirected child window is being or has been successfully set up. Examples of these new window messages may take the form of the following messages sent to the parent window of the child redirected window:

WM_CRCREATE

A child redirected window is being created.

WPARAM: Window handle for the window.

LPARAM: A pointer to CRCREATESTRUCT defined as following:

```
typedef struct tagCRCREATESTRUCT {
    RECT rcPos; initial position of the window.
    BOOL fVisible; if the window is initially visible.
} CRCREATESTRUCT, *LPCRCREATESTRUCT;
```

WM_CRSHOW

A child redirected window is about to be shown.

WPARAM: Window handle for the window.

LPARAM: Boolean value (TRUE for show).

At step 511, the parent window causes any appropriate data structures and the like to be created and initialized by the MIL component 270 to track the child window. At step 513, the MIL component 270 calls the user component 265 to get a handle to the redirected child window.

It should be noted here that the MIL component 270 is effective at tracking and maintaining non-legacy windows through the use of internal data structures and the like. The positions on screen and relative to other non-legacy windows is generally always known by the MIL component 270. Likewise, the user/GDI combination of components is very effective at tracking legacy windows, using their own internal data structures and the like based on the manner in which legacy windows behave. Accordingly, if the MIL component 270 redirects a legacy child window, the MIL component 270 may take advantage of the user component 265, the GDI component 266, or both when managing the redirected child windows. In other words, if it becomes necessary to determine where on a redirected legacy window a particular point is, the MIL component 270 may invoke the user/GDI combination to identify that particular point. Or if something happens that causes the window or a part of the window to need refreshing, the MIL component 270, once it is determined that a redirected child window is affected, may hand off the child window to the user/GDI combination to be refreshed rather than performing all the necessary steps internally.

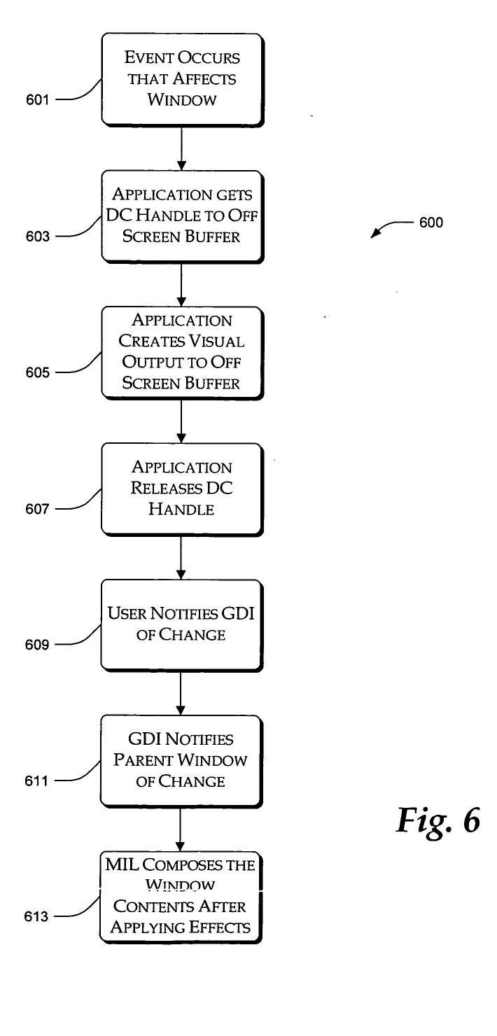

FIG. 6 is a logical flow diagram generally illustrating steps that may be performed in a process 600 for drawing or redrawing windows in a program that includes both legacy windows and new windows. As mentioned above, for windows that are MIL-aware, the MIL component 270 inherently handles the maintenance of the windows. Accordingly, this process 600 focuses on the display of legacy child windows within MIL-aware parent windows. However, it should be appreciated that this process 600 is not the exclusive mechanism for drawing or redrawing windows.

The process 600 begins at step 601, where some event occurs that affects the visual aspects of a window and causes the window to attempt to repaint itself. In this particular example, the window being discussed is a child window of a MIL-aware parent window. Illustrative events that may cause the window to attempt to paint itself include a window being moved or resized, a change in the z-order of visible windows, a change in the window show status, the parent window being closed, and the like.

At step 603, the application gets a Device Context (DC) handle that points to the off-screen version of the window content (i.e., the bitmap buffer). The DC handle is a data structure used by programs and window components to write content to the representation of the window. At step 605, the application writes the visual output to the bitmap buffer, and at step 607 releases the DC handle.

At step 609, once the DC handle is released, the user component 265 notifies the GDI component 266 that the operation is complete. In response, at step 611, the GDI component 266 notifies the parent window of the change. This notification may take many forms, but in this illustrative embodiment, the notification may take the form of one of the following window messages being issued to the parent window:

WM_CRUPDATE

A child redirected window is updated.

WPARAM: Window handle for the window.

LPARAM: A pointer to CRUPDATESTRUCT defined as following:

```
typedef struct tagCRUPDATESTRUCT {
    DWORD dwFlags; see below for description
    POINT ptDest; the new window origin
    RECT rcDirty; the new dirty rect.
} CRUPDATESTRUCT, *LPCRUPDATESTRUCT;
```

dwFlags could be a combination of the following:
CRU_POS child redirection position has changed, use ptDest to get the new origin.
CRU_OUTPUT a portion of the child redirection area is now invalid, use rcDirty to get the dirty rectangle
CRU_SOURCE the window back buffer is now invalid or has changed, refetch the window surface

WM_CRZORDER

A child redirected window zorder has changed.

WPARAM: Window handle for the window.

LPARAM Window handle for the previous window in the z-order list.

WM_CRDESTROY

A child redirected window is destroyed.

WPARAM: Window handle for the window.

LPARAM Not used.

At step 613, the MIL component 270 composes the window contents to the screen buffer after applying any necessary or desired effects, such as those described above. In other words, the MIL component 270 applies any effects to the off-screen representations of the child windows and composes the final parent window using that content in combination with any non-legacy window content. Note that the MIL component 270 could compose the parent window in response to each change to a window or, more likely, it could accumulate changes and compose the parent window on a schedule.

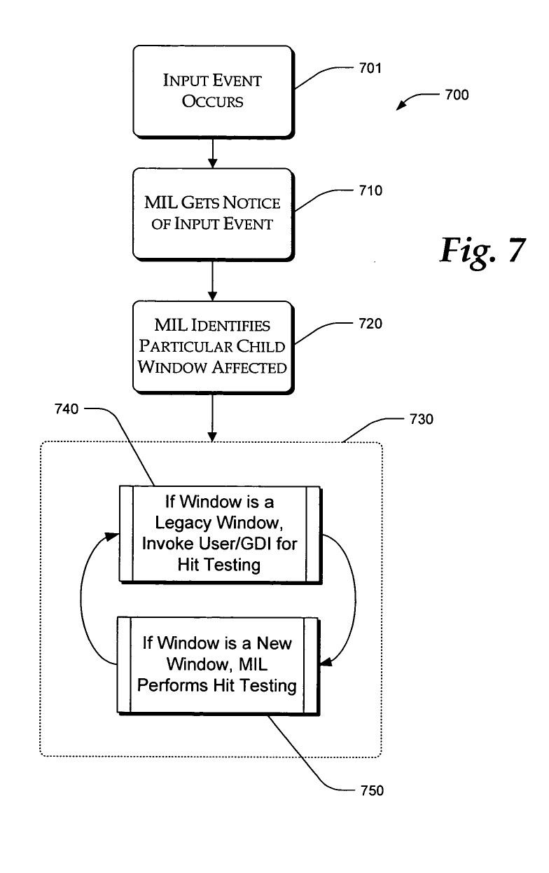

FIG. 7 is a logical flow diagram generally illustrating a process 700 for handling input to a window having both legacy and non-legacy content. The process 700 begins at step 701, where an input event occurs that is directed at a parent window. The most common example of such an input event is the clicking of a mouse button while the mouse pointer is hovering over the parent window. Another example is the touching of or use of a stylus on a touch-sensitive screen in the area of a parent window. These and other events can occur that result in an input event that is transmitted to the parent window.

At step 710, the MIL component 270 receives notice of the input event. For instance, the operating system may first receive notice that the input event occurred from a hardware device driver or the like. The operating system may then pass that message on to the window management and display subsystem 260. At that point, the MIL component 270 receives the notice because the parent window, in this example, is MIL-aware.

At step 720, by evaluating its internal data structures and the like, the MIL component 270 determines that the input event occurred at a screen location corresponding to a legacy child window component. This determination is performed by comparing the screen coordinates associated with the input event notification with the data about the parent window composition. At that point, the process 700 enters a hit testing sub-process 730 where the particular window to which the input was directed is identified.

If the MIL component 270 determines that the input event occurred within the boundaries of a legacy window component, then, at step 740, the MIL component 270 may hand off the task of determining exactly where in the legacy window component the input event occurred. As mentioned above, because the user/GDI combination is particularly well adapted at administering legacy windows, the MIL component 270 may rely on those components to perform “hit testing” (the process of determining where on a window a click or input event occurred so the window that should receive the input event can be identified) for legacy windows. It should be noted that the MIL component 270 does so by performing any relevant coordinate transformations between the as-displayed version of the legacy window component output and the unmodified output. In this way, the user component is unaware that the legacy window output has been modified and believes it is hit-testing a standard ortholinear rectangular window. If the child window is a new window, then, at step 750, the MIL component 270 performs the hit testing.

In many instances, windows are nested within other windows. A parent window may have one child window, and that child window may have its own children. The frame 315 and option buttons illustrated in FIG. 3 are examples of this construct. It should be noted that new windows could be used as children of a legacy window. In that case, the hit testing process 730 may involve iterating back and forth between step 740 and step 750 to identify the particular location within a child window or on a window component that the input event occurred. The MIL component 270 will likely administrate these operations.

In summary, the techniques and mechanisms described above enable a software developer to create new applications with some legacy window components while still taking advantage of new visual enhancements of which those legacy window components are unaware. This allows a smooth migration path for software developers. Moreover, the legacy window components may be used without any changes, and hence are completely unaware that any redirection has occurred.

Another noteworthy advantage is that these techniques and mechanisms enable window components that may have been created for use in one display environment with a fixed or limited resolution to appear properly in higher-resolution environments. In other words, a window component that was created to be visually appealing at a certain resolution may be too small when displayed at a the resolutions available with later-developed technology. The system described above enables the visual output of the window component (created at a static resolution) to be dynamically scaled based on the current display resolution. This ability has been unavailable before now.

The subject matter described above can be implemented in software, hardware, firmware, or in any combination of those. In certain implementations, the exemplary techniques and mechanisms may be described in the general context of computer-executable instructions, such as program modules, being executed by a computer. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A computer-executable method, comprising:
determining if a child window of a parent window is a legacy window;
if so, causing the child window output to be redirected to an off-screen buffer;
retrieving the child window output from the off-screen buffer;
applying a visual enhancement to the child window output; and
composing a visual representation of the parent window with the visually enhanced child window output.

2. The method recited in claim 1, wherein the legacy window is configured to be administered by a legacy display component having fewer visual enhancements than a Media Integration Layer (MIL) component.

3. The method recited in claim 2, wherein causing the child window output to be redirected comprises instructing the legacy display component to redirect the child window output to the off-screen buffer.

4. The method recited in claim 3, wherein the legacy display component comprises a user subcomponent and a Graphics Device Interface subcomponent.

5. The method recited in claim 1, wherein the visual enhancement comprises a selected one or more from a group comprising re-sizing, re-shaping, relocating window component output, applying transparency, rotating and translating window component output, and applying a texture or visual effect to the window component output.

6. The method recited in claim 1, wherein the visual enhancement comprises scaling the child window output to reflect a different screen resolution than originally applicable.

7. The method recited in claim 1, wherein composing the visual representation of the parent window is performed by the MIL component.

8. A computer-readable medium having computer-executable instructions for performing the method recited in claim 1.

9. A computer-executable method, comprising:
receiving a notification that an input event occurred, the input event including a location on a screen display, the location being within a boundary of a parent window, the parent window being compatible with a MIL component;
determining where on the parent window the input event occurred by:
evaluating the notification to identify which of a plurality of windows corresponds to the location;
if the location is within a boundary of a non-legacy child window, evaluating where on the non-legacy child window the input event occurred;
if the location is within a boundary of a legacy child window, the child window being a legacy window that does not have native capability to interact with the MIL component, referring the notification to a legacy display component; and
notifying an appropriate child window of the input event, the appropriate child window corresponding to the location.

10. The method recited in claim 9, further comprising:
receiving a notification that the input event occurred within a boundary of a second child window, the second child window being a child of the first child window, and repeating the determination step for the first child window.

11. The method recited in claim 9, wherein evaluating the notification comprises evaluating data structures associated with the MIL component that describe relationships between the parent window and a plurality of child windows on the parent window.

12. The method recited in claim 11, wherein the data structures do not include information about other windows that are legacy children of legacy child windows on the parent window.

13. The method recited in claim 11, wherein the data structures include information about other windows that are non-legacy children of legacy child windows on the parent window.

14. The method recited in claim 9, wherein the determining step is a cooperative process between the MIL component and the legacy display component.

15. The method recited in claim 14, wherein the legacy display component maintains information about the layout of legacy child windows, and wherein the MIL component maintains information about the layout of non-legacy child windows.

16. A computer-readable medium having computer-executable instructions for performing the method recited in claim 9.

17. A computer-executable medium having computer executable components, comprising
a user component configured to create an off-screen buffer upon detecting the presence of a legacy child window of a parent window;
a GDI component configured to redirect window output from the legacy child window upon being notified by the user component of the existence of the legacy child window; and
a MIL component configured to apply a visual enhancement to the redirected window output in connection with composing the parent window for display on a display device.

18. The method recited in claim 17, wherein the user component maintains data structures that describe a layout and position of the legacy child window and its legacy children.

19. The method recited in claim 17, wherein the MIL component maintains data structures that describe a layout and position of the parent window and its children.

20. The method recited in claim 19, wherein the visual enhancement is at least one of a plurality of visual enhancements comprising re-sizing, re-shaping, relocating window component output, applying transparency, rotating and translating window component output, applying a texture or visual effect to the window component output, and scaling the legacy child window output to reflect a different screen resolution than originally applicable.

21. The method recited in claim 17, wherein the MIL component is further configured to interact with the user component and the GDI component to identify a location on a child window of the parent window corresponding to a location of an input event.

22. A computer-readable medium having computer executable instructions comprising:
in a system having a display component for issuing instructions to notify a parent window of the creation of a redirected child window, means for notifying the parent window that the redirected child window is being or has been set up.

23. The computer-readable medium recited in claim 22, wherein the means for notifying the parent comprises a window message indicating that the redirected child window is being created.

24. The computer-readable medium recited in claim 23, wherein the window message includes a window handle to the redirected child window.

25. The computer-readable medium recited in claim 22, wherein the means for notifying the parent comprises a window message indicating that the redirected child window is about to be shown.

26. The computer-readable medium recited in claim 25, wherein the window message includes a window handle to the redirected child window.

27. A computer-readable medium having computer executable instructions comprising:
in a system having a display component for issuing instructions to notify a parent window of the creation of a redirected child window, means for notifying the parent window of a change that affects the redirected child window.

28. The computer-readable medium recited in claim 27, wherein the means for notifying the parent comprises a window message indicating that the redirected child window has been updated.

29. The computer-readable medium recited in claim 28, wherein the window message further comprises information that describes the change to the redirected child window.

30. The computer-readable medium recited in claim 27, wherein the means for notifying the parent comprises a window message indicating that the redirected child window has experienced a change in z-order.

31. The computer-readable medium recited in claim 30, wherein the window message further comprises a handle to a previous window in the z-order.

32. The computer-readable medium recited in claim 27, wherein the means for notifying the parent comprises a window message indicating that the redirected child window has been destroyed.
